(19) United States
(12) Patent Application Publication
(10) Pub. No.: US 2005/0078920 A1
(43) Pub. Date: Apr. 14, 2005

(54) Micro optical communication device package

(76) Inventors: Yeong Gyu Lee, Suwon (KR); Seong Hun Lee, Suwon (KR); Sung Cheon Jung, Suwon (KR); Moo Youn Park, Kwangmyung (KR); Suk Kee Hong, Seoul (KR)

Correspondence Address: LOWE HAUPTMAN GOPSTEIN GILMAN & BERNER, LLP, Suite 310, 1700 Diagonal Road, Alexandria, VA, 22314, US

(21) Appl. No.: 10/734,146

(22) Filed: Dec. 15, 2003

(30) Foreign Application Priority Data
Oct. 10, 2003 (KR) 2003-70655

(51) Int. Cl. G02B 6/36

(52) U.S. Cl. 385/92; 385/88

(57) ABSTRACT

The present invention relates to a micro optical communication device package. The package of the invention comprises a Micro-Electro-Mechanical System (MEMS) chip for executing an optical communication function. The MEMS chip is mounted on a base. An upper housing having an opened bottom is placed on the base to form an internal space together with the base. The upper housing is sealed with the base to hermetically seal the MEMS chip within the internal space. The MEMS chip is connected an optical fiber, which is extended through the upper housing to form a light path. A boot is fit around the optical fiber and fixed to the upper housing to seal a portion of the upper housing for allowing passage of the optical fiber.

### BACKGROUND OF THE INVENTION

1. Field of the Invention

The present invention relates to a micro optical communication device package based upon the Micro Electro-Mechanical System (MEMS) Technology, more particularly, which combines a hermetic sealing structure for blocking external environment and an outer housing structure into a single housing structure which can hermetically seal the micro optical communication device package while housing the same.

2. Description of the Related Art

The MEMS Technology incorporates electronic, mechanical and optical technologies to design, fabricate and utilize miniature (microscale or microscopic) components and systems. The MEMS technology can minimize product size through batch production on a wafer based upon semiconductor processing as well as integrate a plurality of functional elements and signal processing modules into a single chip product which has high performance and reliability.

Since the MEMS Technology can precisely regulate and control light, it has been applied to a variety of optical devices such as a Variable Optical Attenuator, Optical Switch and Optical Add-Drop Module (OADM).

The MEMS Technology may fabricate an optical communication device as follows: The optical communication device is designed first, a MEMS chip is fabricated according to the design, and then the MEMS chip is packaged. According to an aspect of the optical communication device based upon the MEMS Technology, the optical communication device itself contains an optical fiber. This reveals that the process step of packaging the optical communication device is one of decisive factors for the optical performance, reliability and price of an optical product.

Fabrication of the optical devices requires hermetic sealing that protects the optical devices from invasion of foreign materials such as moisture and dust, in particular, since the optical devices each contain a microscopic driving unit. As a result, each optical device based upon the MEMS Technology is so designed that the hermetic sealing is performed to a housing thereof.

FIG. 1 illustrates a structure of an optical device package based upon the MEMS Technology of the prior art. As shown in FIG. 1, the optical device package of the prior art comprises an upper housing 16 and a lower housing 17. The upper and lower housings 16 and 17 are joined together into a substantially rectangular box, which contains a board 12 and an optical fiber 14 therein. In the box, a MEMS chip 13 functioning as an optical switch or an optical attenuator is mounted on the board 12 via a base 18. The base 18 has a plurality of terminals extended downward and a top portion for mounting the MEMS chip 13. The base 18 is attached on the board 12, and the terminals of the base 18 are connected with patterns of the board 12. The optical fiber 14 defining an optical path is connected with the MEMS chip 13 on the base 18 of the board 12.

Since the MEMS chip 13 mounted on the board 12 requires hermetic sealing from the external environment, a cap 11 is disposed over the MEMS chip 13 to hermetically seal the MEMS chip 13. Since the optical fiber 14 passes through lateral portions of the upper and lower housings 16 and 17 extending itself to the outside, boots 15 are fit around the optical fiber 14 at the opened lateral portions of the housing 16 and 17 to fix the optical fiber 14 in position or seal the opened lateral portions of the housings 16 and 17. Since the optical fiber 14 may be bent sharply or slip through the perforated lateral portions of the housings 16 and 17, the boots 15 serve to prevent such bending or slippage of the optical fiber 14 so that the optical fiber 14 can be stably connected with the chip 13 mounted in the housings 16 and 17. The boots 15 also serves to prevent invasion of foreign materials into the housings 16 and 17.

FIGS. 2A through 2C illustrate a packaging process of an optical fiber of the prior art as shown in FIG. 1. Referring to FIG. 2A, a MEMS chip 13 is mounted on a base 18. Next, an optical fiber 14 is connected with the chip 13 as shown in FIG. 2B. Then, a cap 11 is covered on the base 18 as shown in FIG. 2C to seal the MEMS chip 13. When the cap 11 is covered on the base 18, epoxy resin is coated on contact areas of the cap 11 and the base 18 so that the cap 11 is hermetically attached to the base 18.

As shown in FIGS. 1 through 2C, the MEMS chip 13 is mounted on the board 12 as hermetically sealed by the cap and the base 18. Further, the board 12 is encased into the upper and lower housings 16 and 17, and the optical fiber 14 is fixed in position by the boots 15 which are in contact with the housings 16 and 17.

Since the above packaging process is subject to several packaging procedures, the optical device package of the above structure has drawbacks of a long process time and complicated manual works. Further, epoxy resin may not be coated on the contact areas of the cap and the base at a uniform quantity, thereby potentially creating delamination or crack in poorly coated regions. Moreover, an adhesive such as epoxy resin may be changed in characteristics with respect to temperature since it tends to deform under heat or moisture.

### SUMMARY OF THE INVENTION

The present invention has been made to solve the foregoing problems and it is therefore an object of the present invention to provide an optical communication device package which combines a hermetic sealing structure together with a housing structure in order to simplify a package structure and a fabrication process thereof.

It is another object of the invention to provide an optical communication device package which can be fabricated via ultrasonic welding instead of conventional adhesive coating, which suffers from the influence for example of temperature and tends to have defects according to coating thickness, so that the optical communication device package can be facilitated simply and/or automated without defect sources.

According to an aspect of the invention for realizing the object, there is provided a micro optical communication device package comprising: a Micro-Electro-Mechanical System (MEMS) chip for executing an optical communication function; a base for mounting the MEMS chip; an upper housing having an opened bottom and placed on the base to form an internal space together with the base, the upper housing being sealed with the base to hermetically seal the MEMS chip within the internal space; an optical fiber connected with the MEMS chip through the upper housing to form a light path; and a boot fit around the optical fiber and fixed to the upper housing to seal a portion of the upper housing for allowing passage of the optical fiber.

It is preferred that the boot has one end closely adhering and fixing to the upper housing and the other end closely adhering and fixing to an outer periphery of the optical fiber, and the upper housing has a port which is opened downward so that the boot can be inserted through the port, wherein the one end of the boot is fixedly inserted into the port.

It is also preferred that the boot is made of an elastic material, and the one end of the boot is bonded with the port of the upper housing via ultrasonic welding.

It is preferred that the boot, the upper housing and the optical fiber closely adhere and fix to one another via an adhesive which naturally cures under ultraviolet light or heat.

It is also preferred that the upper housing and the base are hermetically sealed with each other via ultrasonic welding, and the upper housing and the base are made of Acrylonitrile Butadiene Styrene (ABS) or polycarbonate (PC).

It is also preferred that the upper housing has a protrusion projected downward, and the base has a protrusion-receiving portion.

According to another aspect of the invention for realizing the object, there is provided a micro optical communication device package comprising: micro optical communication device package comprising: a Micro-Electro-Mechanical System (MEMS) chip for executing an optical communication function; a base for mounting the MEMS chip; an upper housing having an opened bottom and placed on the base to form an internal space together with the base, the upper housing being sealed with the base to hermetically seal the MEMS chip within the internal space, and having a port which is opened downward adjacent to the opened bottom; an optical fiber connected with the MEMS chip through the upper housing to form a light path; and a boot fit around the optical fiber and fixed to the upper housing to seal the port of the upper housing for allowing passage of the optical fiber, the boot having one end closely adhering and fixing to the upper housing and the other end closely adhering and fixing to an outer periphery of the optical fiber.

It is preferred that the boot is made of an elastic material, and the one end of the boot is bonded with the port of the upper housing via ultrasonic welding. It is also preferred that the boot, the upper housing and the optical fiber closely adhere and fix to one another via an adhesive which naturally cures under ultraviolet light or heat.

According to further another aspect of the invention for realizing the object, there is provided a micro optical communication device package comprising: micro optical communication device package comprising: a Micro-Electro-Mechanical System (MEMS) chip for executing an optical communication function; abase for mounting the MEMS chip; an upper housing having an opened bottom and placed on the base to form an internal space together with the base, the upper housing being sealed with the base via ultrasonic welding to hermetically seal the MEMS chip within the internal space; an optical fiber connected with the MEMS chip through the upper housing for forming a light path; and a boot fit around the optical fiber and fixed to the upper housing to seal a portion of the upper housing for allowing passage of the optical fiber.

It is preferred that the upper housing and the base are made of Acrylonitrile Butadiene Styrene (ABS) or polycarbonate (PC).

It is also preferred that the upper housing has a protrusion projected downward, and the base has a protrusion-receiving portion.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating an assembled structure of an optical communication device package of the prior art;

FIGS. 2A through 2C are perspective views illustrating a hermetic sealing process of a chip of the optical communication device package shown in FIG. 1;

FIG. 3 is a perspective view illustrating an optical communication device package in accordance with the invention;

FIG. 4 is a sectional view illustrating an internal structure of the optical communication device package in FIG. 3;

FIG. 5 is a perspective view illustrating an upper housing of the optical communication device package in FIG. 3;

FIG. 6 is a perspective view illustrating a boot of the optical communication device package in FIG. 3; and

FIG. 7 is a perspective view illustrating an alternative to the coupling structure of the upper and lower housings of the optical communication device package in FIG. 3.

### DETAILED DESCRIPTION OF THE PREFERRED EMBODIMENT

Hereinafter, preferred embodiments of the present invention will be described in detail with reference to the attached drawings.

According to an aspect of the present invention, an optical communication device package of the present invention hermetically seals a MEMS chip with a base for mounting the MEMS chip and an upper housing for covering the base while functioning as an enclosure or housing for containing the MEMS chip.

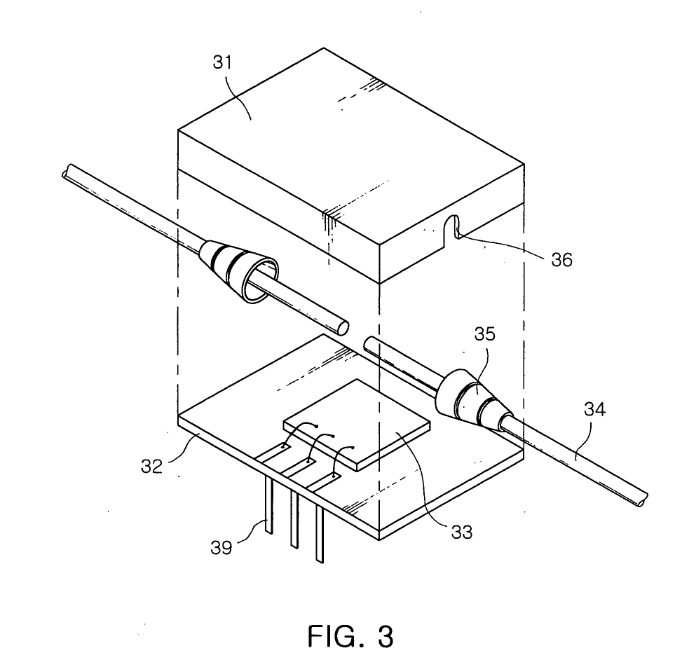

FIG. 3 is a perspective view illustrating an optical communication device package in accordance with the invention. Referring to FIG. 3, a Micro Electro-Mechanical System (MEMS) chip 33 executing an optical communication function is mounted on a base 32. The MEMS chip 33 is a microscopic chip which is designed to regulate and control a trace amount of light based upon the MEMS Technology. Available examples of the MEMS chip may include an optical attenuator, an optical switch, OADM and so on. Since the MEMS chip 33 contains a microscopic driving unit therein, hermetic sealing is required to protect the MEMS chip 33 from foreign materials such as moisture and dust.

The MEMS chip 33 is mounted on the base 32 with its patterns connected with terminals 39. The base 32 functions as a board as well as an enclosure or housing for mounting the MEMS chip 33 therein.

In a top portion of the base 32, the patterns are electrically connected with the MEMS chip 33 which is mounted on the top portion of the base 32. The patterns are connected with the terminals 39 which are extended downward perpendicularly through the base 32. The MEMS chip 33 may be electrically connected with the patterns on the base 32 via several techniques such as wire bonding.

An upper housing 32 opened in a bottom portion is covered on the base 32. The upper housing 32 is shaped as a substantially rectangular box, with the bottom portion being opened. The upper housing 31 is joined with the base 32 to form an internal space for housing the MEMS chip 33 mounted on the base 32. It is necessary to hermetically isolate the internal space housing the MEMS chip 33 from the outside. Therefore, it is important to hermetically bond the base 32 with the upper housing 31.

The invention applies ultrasonic welding to hermetic bonding the upper housing 31 and the base 32. In the ultrasonic welding, two sheets to be welded are overlapped on each other, and then transverse or longitudinal vibration of ultrasonic wave is applied to the overlapped sheets to create friction between contact areas of the overlapped sheets while constant pressure is applied to a side of the overlapped sheets. In particular, materials made of resin can be welded together completely in a rapid and simple fashion via the ultrasonic welding.

The ultrasonic welding is performed with an ultrasonic plastic welder, which transforms electric power of about 100 to 250V at a frequency of about 50 to 60 Hz into electric energy at a frequency of about 20,000 to 40,000 Hz with a power supply and then converts the electric energy with a converter into mechanical vibration energy while adjusting the amplitude of the mechanical vibration energy. When transmitted into any materials to be welded, the ultrasonic vibration energy formed as above gives instantaneous friction heat to contact areas of the materials creating strong molecular bonding force so that the contact areas are welded together completely.

As a result, the vibration energy transmitted into both of the upper housing 31 and the base 32, which are in close contact with each other, generates instantaneous friction heat in contact areas of the upper housing and the base, resulting in molecular bonding force which completely welds the contact faces together. There is an advantage that the ultrasonic welding can be carried out simply compared to a conventional process of coating epoxy resin on the contact faces. According to the ultrasonic welding, the contact faces can maintain uniform strength without defects such as crack.

In order to enable the ultrasonic welding, the upper housing 31 and the base 32 may be made of resin such as ABS, in the short form of Acrylonitrile Butadiene Styrene. Alternatively, the upper housing 31 and the base 32 can be made of Polycarbonate (PC) Selection of any of the above materials enables application of the ultrasonic welding through transmission of the ultrasonic vibration energy.

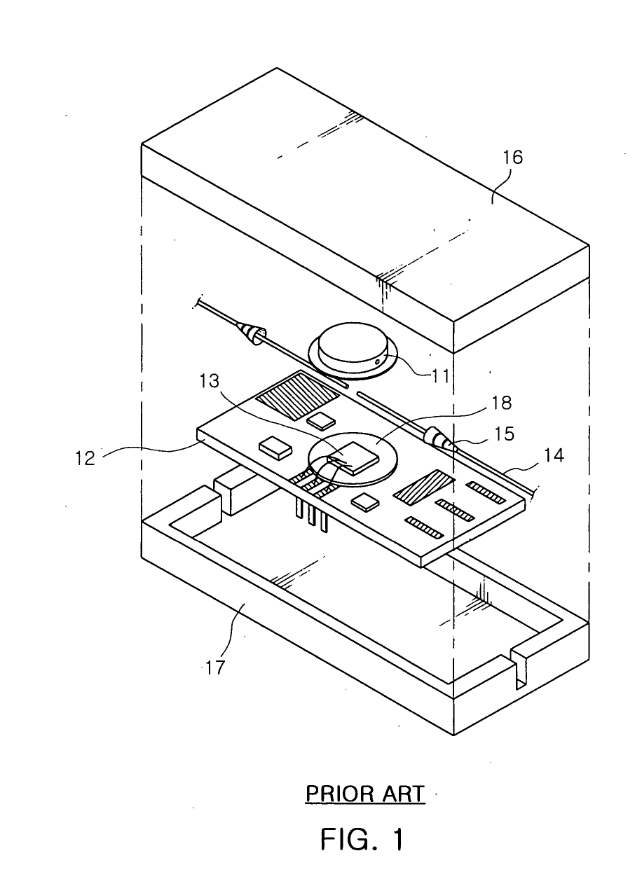

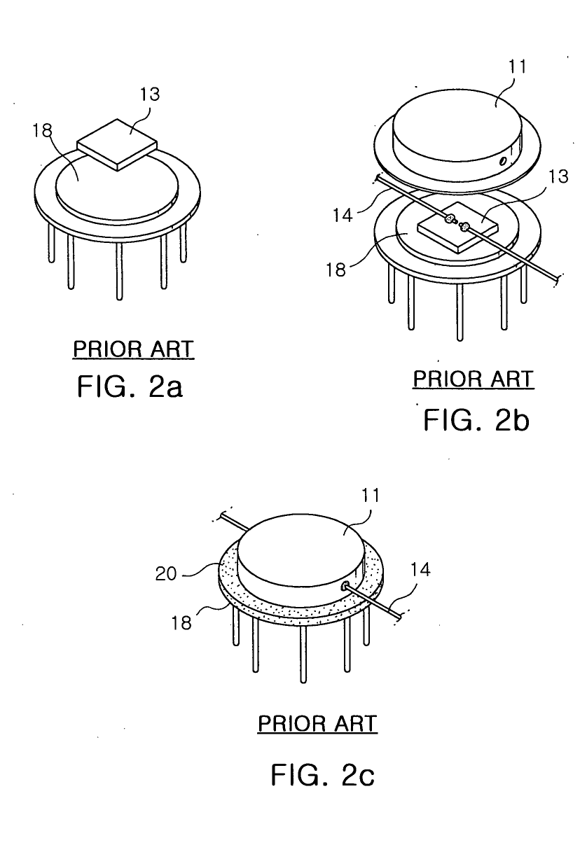

When the upper housing 31 is covered on the base 32 mounted with the chip 33 to hermetically seal the chip 33, it is troublesome to connect the chip 33 with an optical fiber 34 which is extended from the outside. In the prior art, the chip 13 is hermetically sealed via the cap 11 and then connected with the optical fiber 34 through the boots 35 which are connected with the housings 16 and 17. (Refer to FIGS. 1 through 2C.) However, the present invention hermetically bonds the upper housing with the base via the ultrasonic welding to form the hermetic sealing structure which also functions as an outer housing or enclosure so that the upper and lower housings of the prior art can be incorporated into the single structure.

As a result, there is required a technique for connecting the optical fiber 34 with the chip 33 and fixing the same within the upper housing 31. The optical fiber 34 is connected with the chip 31 through the upper housing 31 to transmit light both into the housing 31 and to the outside. It is necessary for the optical fiber 34 to be connected with the chip 33 without bending or break in order to form a light path. The optical fiber 34 may be bent according to outer array. So, the boots 35 serve to stably connect the optical fiber 34 with the chip 33 regardless of various factors such as bending and shaking.

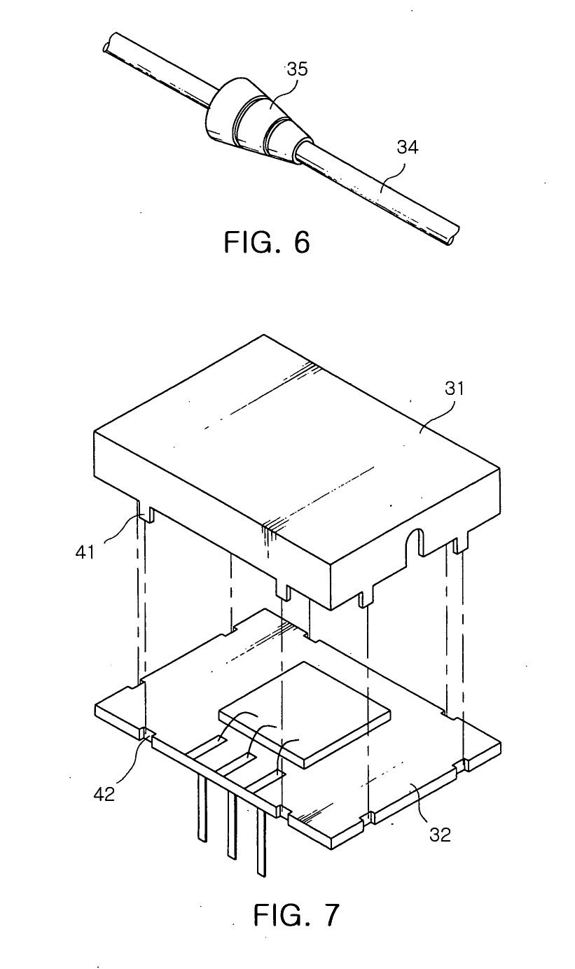

The boots 35 are fixed to the upper housing 31, fit around the optical fiber 34, in order to seal portions of the upper housing 31 for allowing passage of the optical fiber 34. The boots 36 fit around the optical fiber are substantially conical as shown in FIG. 6. Both ends of each of the boots 35 are opened, with one end of a larger area closely adhering and fixing to the upper housing 31 and the other one of a smaller area closely adhering and fixing to the optical fiber.

The upper housing 31 is provided with ports 36 which are opened downward, as sown in FIG. 5, to allow insertion of the boots 35 into the same. The boots 35 are bonded with the upper housing 31, with the one ends being inserted into the ports 36 of the upper housing 31. The boots 36 may be bonded to the upper housing 31 via the ultrasonic welding and so on. The ultrasonic welding can weld contact areas of the boots 36 and the upper housing 31 together uniformly and stably, with excellent sealing effect. Therefore, the boots, the upper housing and the base which are commonly made of resin can be completed maintaining hermetic sealing among them.

Alternatively, the boots 35 can be bonded to the upper housing 31 with a typical hermetic sealing adhesive (e.g., epoxy resin) which naturally cures under ultraviolet light or heat. Since the contact areas between the boots 35 and the upper housing 31 are smaller than the contact areas between the upper housing 31 and the base 32, the typical hermetic sealing adhesive for bonding the boots 35 and the upper housing 31 may not create serious problems such as ununiformity.

The other ends of the boots 35 can closely adhere and fix to the optical fiber 34 via an adhesive which naturally cures under ultraviolet light or heat. That is, an adhesive resin such as epoxy resin is coated on the contact areas of the boots 35.

Since the boots 35 are made of an elastic material and have an internal spaces for surrounding the optical fiber 34, the boots 35 compensate bending of the optical fiber 34 within a predetermined range of angles so that bending at a region of the optical fiber 34 does not propagate to other portions thereof which are connected with the chip 33.

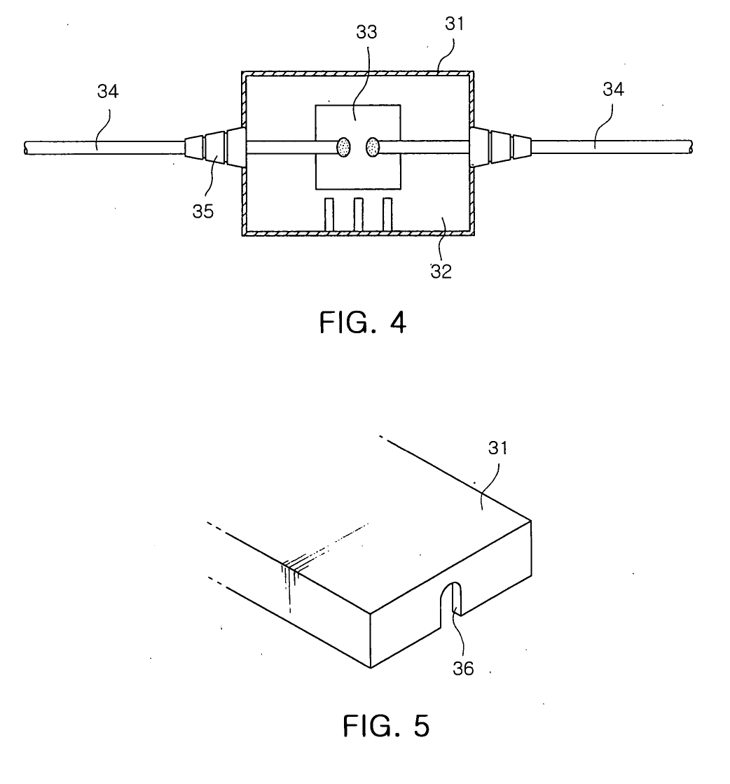

FIG. 4 is a sectional view illustrating an internal structure of the optical communication device package in FIG. 3. Referring to FIG. 4, the chip 33 is placed on the base 32, connected with the optical fiber 34. The optical fiber 34 is fixed in position by boots 35 at interfaces between the upper housing and the base. The boots 35 also serve to seal the ports 36 of the upper housing 31 for allowing passage of the optical fiber 34.

As set forth above, the present invention utilizes the ultrasonic welding to hermetically bond the upper housing with the base as well as closely fix the boots to the upper housing so that the upper housing and the base can serve as an enclosure. As a result, the present invention simplifies the package structure which was complicated in the prior art.

Alternatively, the present invention may adopt a coupling structure between an upper housing and a base as shown in FIG. 7 in order to further facilitate the afore-described ultrasonic welding. FIG. 7 is a perspective view illustrating an alternative to the coupling structure of the upper and lower housings of the optical communication device package in FIG. 3.

Referring to FIG. 7, the upper housing 31 is provided with protrusions 41 which are projected downward from an underside of the upper housing 31 with predetermined spacings. The base 32 is provided with recesses 42 each for receiving each of the protrusions 41 so that the each protrusion 41 can be inserted into the each recess 42. Since this structure primarily couples the upper housing 31 with the base 32 before the ultrasonic welding, welding positions of the upper housing 31 and the base 32 are not misaligned or changed while the ultrasonic welding is performed.

The optical communication device package of the invention adopts a single hermetic sealing structure which also functions as an outer housing or enclosure. Since those materials such as epoxy resin deformable under heat or moisture were used for the purpose of hermetic sealing, the prior art formed a secondary hermetic sealing to prevent introduction of external heat or moisture and provided an additional housing for coupling with the boots to stably maintain the optical fiber in position. However, since the ultrasonic welding replaces the conventional epoxy resin bonding to couple the upper housing with the base, the optical communication device package of the present invention can effectively resist heat and moisture, thereby excluding the outer housing of the prior art.

Further, the boots for stably maintaining the optical fiber in position can be hermetically welded to the optical communication device package of the present invention via the ultrasonic welding. That is, the boots, the upper housing and the base can be ultrasonic welded simultaneously or separately since they are made of resin which can be processed via the ultrasonic welding. Moreover, according to the ultrasonic welding, a fabrication process of the optical communication device package of the present invention can be carried out simply since the number of its steps is reduced compared with that of conventional fabrication processes. The fabrication process of the optical communication device package of the invention also can be improved through automation.

Further, the conventional outer housing is excluded to reduce the size of the optical communication device package of the invention. Moreover, since the overall contact faces are welded or bonded together with uniform strength, the present invention can prevent defects such as crack which are caused by strength degradation.

Although the preferred embodiment of the present invention has been disclosed for illustrative purposes, those skilled in the art will appreciate that various modifications, additions and substitutions can be made without departing from the scope and spirit of the invention as disclosed in the accompanying claims.

1. A micro optical communication device package comprising:
a Micro-Electro-Mechanical System (MEMS) chip for executing an optical communication function;
a base for mounting the MEMS chip;
an upper housing having an opened bottom and placed on the base to form an internal space together with the base, the upper housing being sealed with the base to hermetically seal the MEMS chip within the internal space;
an optical fiber connected with the MEMS chip through the upper housing to form a light path; and
a boot fit around the optical fiber and fixed to the upper housing to seal a portion of the upper housing for allowing passage of the optical fiber.

2. The micro optical communication device package as set forth in claim 1, wherein the boot has one end closely adhering and fixing to the upper housing and the other end closely adhering and fixing to an outer periphery of the optical fiber.

3. The micro optical communication device package as set forth in claim 2, wherein the upper housing has a port which is opened downward so that the boot can be inserted through the port, wherein the one end of the boot is fixedly inserted into the port.

4. The micro optical communication device package as set forth in claim 3, wherein the boot is made of an elastic material.

5. The micro optical communication device package as set forth in claim 3, wherein the one end of the boot is bonded with the port of the upper housing via ultrasonic welding.

6. The micro optical communication device package as set forth in claim 3, wherein the boot, the upper housing and the optical fiber closely adhere and fix to one another via an adhesive which naturally cures under ultraviolet light or heat.

7. The micro optical communication device package as set forth in claim 1, wherein the upper housing and the base are hermetically sealed with each other via ultrasonic welding.

8. The micro optical communication device package as set forth in claim 7, wherein the upper housing and the base are made of Acrylonitrile Butadiene Styrene (ABS).

9. The micro optical communication device package as set forth in claim 7, wherein the upper housing and the base are made of polycarbonate (PC).

10. The micro optical communication device package as set forth in claim 7, wherein the upper housing has a protrusion projected downward, and the base has a protrusion-receiving portion.

11. A micro optical communication device package comprising:
a Micro-Electro-Mechanical System (MEMS) chip for executing an optical communication function;
a base for mounting the MEMS chip;
an upper housing having an opened bottom and placed on the base to form an internal space together with the base, the upper housing being sealed with the base to hermetically seal the MEMS chip within the internal space, and having a port which is opened downward adjacent to the opened bottom;
an optical fiber connected with the MEMS chip through the upper housing to form a light path; and
a boot fit around the optical fiber and fixed to the upper housing to seal the port of the upper housing for allowing passage of the optical fiber, the boot having one end closely adhering and fixing to the upper housing and the other end closely adhering and fixing to an outer periphery of the optical fiber.

12. The micro optical communication device package as set forth in claim 11, wherein the boot is made of an elastic material.

13. The micro optical communication device package as set forth in claim 11, wherein the one end of the boot is bonded with the port of the upper housing via ultrasonic welding.

14. The micro optical communication device package as set forth in claim 11, wherein the boot, the upper housing and the optical fiber closely adhere and fix to one another via an adhesive which naturally cures under ultraviolet light or heat.

15. A micro optical communication device package comprising:
a Micro-Electro-Mechanical System (MEMS) chip for executing an optical communication function;
a base for mounting the MEMS chip;
an upper housing having an opened bottom and placed on the base to form an internal space together with the base, the upper housing being sealed with the base via ultrasonic welding to hermetically seal the MEMS chip within the internal space;
an optical fiber connected with the MEMS chip through the upper housing for forming a light path; and
a boot fit around the optical fiber and fixed to the upper housing to seal a portion of the upper housing for allowing passage of the optical fiber.

16. The micro optical communication device package as set forth in claim 15, wherein the upper housing and the base are made of Acrylonitrile Butadiene Styrene (ABS).

17. The micro optical communication device package as set forth in claim 15, wherein the upper housing and the base are made of polycarbonate (PC).

18. The micro optical communication device package as set forth in claim 15, wherein the upper housing has a protrusion projected downward, and the base has a protrusion-receiving portion.
